(19) United States
(12) Patent Application Publication
(10) Pub. No.: US 2019/0011956 A1
(43) Pub. Date: Jan. 10, 2019

(54) No Tech Notebook

(71) Applicant: James Clinton Veon, Upper Marlboro, MD (US)

(72) Inventor: James Clinton Veon, Upper Marlboro, MD (US)

(21) Appl. No.: 15/700,035

(22) Filed: Sep. 8, 2017

Related U.S. Application Data
(60) Provisional application No. 62/530,000, filed on Jul. 7, 2017.

(51) Int. Cl. G06F 1/16; G06F 13/40

(52) U.S. Cl. CPC G06F 1/1658; G06F 13/4072

(57) ABSTRACT

Notebook with removable peripherals for simple service and repair. Eliminates the need to hire or allow a 3^{rd} party computer technician when a hardware malfunction or accidental breakage occurs.

### SYSTEM OVERVIEW

This invention will look, feel, weigh and function just as a typical industry standard Notebook computer you would find at any electronics store or computer seller website.

The Notebook will differ in how it is maintained and/or serviced. Traditionally the process of repairing a Notebook computer with a hardware malfunction is to call a service organization, either where you made the purchase or a 3^{rd} party repair shop that you may know or find on your own. You may need to ship the Notebook out somewhere to be repaired and returned to you in restored condition, or take it to a shop and drop it off for repair, hopefully receiving it back in working condition after a few days or weeks. Lastly, a technician might have to make a house call leaving you to deal with a person you may or may not know or trust. Inviting a technician into your home without a back ground history, or even knowing their location an hour before arrival at your home can be uncomfortable leaving you to wonder, do you leave them to work on their own or do you watch what they do in your home and to your Notebook computer.

### IMPROVEMENT

In order for this improvement to become effective, the Notebook shall need a design different from any other Notebook manufactured today. The key advantage of the design is to make the main peripheral components interconnected via an interface with a Male Plug and fasten to a Female Jack located on the Notebook Mainboard. The advantage of plug/jack technology is to enable a quick yet durable electronic connection that can transmit power and data signal together to run the peripherals in a versatile and efficient component.

Essentially every component connects to a mainboard on any PC or Notebook computer. The mainboard also is the center of processing, so as a traditional Notebook has the slots for memory and CPU, so will the mainboard for this Notebook. Access to the memory and CPU slots will be thru doors on the bottom of the base unit. The base unit will contain the mainboard, keyboard, and touchpad. The base unit will also contain corner posts for the screen component to connect via the screen hinges which have the ability to rotate 360 degrees enabling the Notebook to fold over and be used as a Tablet unit also with a touchscreen feature and will contain a Stylus Pen for writing and tapping.

The Hard Drive connection is best suited to be a SATA connection due to the dedicated industry standard hard drive connector.

The plug/jack component device fastener systems advantage is its ability to easily be connected or disconnected by a person owner/user to manage and self service the Notebook themselves. In addition the component will have slots on each side for an adequate length to make sure the device seats easily and efficiently without damaging the interface of the plug or jack. The jack connection located on the component device will have a protective plastic jacket for protecting the pins on the components jack and will fit snug over the plug. Then fastener to the base unit will be a form fitted flange having 2 screw holes and 2 screws that are permanently seated for quick attaching and detaching without loosing the screws.

### ADVANTAGE

With this new invention, you decide which device on your new Notebook is having the trouble by using the online help or phone help provided by the company. You determine a replacement part based on your diagnosis and the professional opinion of this company who backs the new Notebook you purchased.

Next you order a replacement part based on your urgency to have the part shipped, overnight or ground delivery or possible pick up at a parts distribution center if there is one in your vicinity. When your part arrives you simply disconnect the malfunctioning part and install the new replacement part you ordered and received. The tools needed to do a part replacement will come with your new part and is a small straight edge screw driver.

Should there be an additional issue with your Notebook you simply repeat the troubleshooting process until the unit is back to working condition even if it requires you to replace the base unit. Because there is the color coding scheme to assist with part recognition and familiarity, the person using the Notebook (owner/user) will be able to understand more about how their new Notebook works and what each components purpose is and how the whole unit operates.

### DIFFERENCE

Other Notebook computers have been equipped with a Module or Modular Bay which makes it possible to interchange between a CPU, Memory, Floppy Disk Drive, a CD Drive or CD/DVD Drive, an additional battery or possibly an additional Hard Drive. The attraction is versatility of that device and having multiple options to use various devices too many to build in permanently.

This invention differs from that entirely because there is no need to add or exchange different devices in this new Notebook. The removal and replacement of devices is solely for the purpose of maintaining and repairing a malfunctioning Notebook due to a hardware failure or an accident causing a hardware malfunction.

Another difference from a previously invented Modular Notebook design is this Notebook does not have or need a removable module for CPU or Memory, these parts are built into the base and their critical nature should not be altered or removed from the Base Unit. The base unit could be replaced in order to upgrade to higher performance and transfer peripheral components to the new Base Unit.

### FINANCIAL BENEFIT

Typical Notebook or PC malfunctions may be caused by a user trying to plug in a USB device upside down and shorting out the USB controller, plugging in a VGA or HDMI cable upside down causing pins to be bent or severed and could short out the Graphics adapter. Replacing a small module will be much more cost effective than sending a whole unit out for repair.

Spills on the Keyboard or Touch pad could short out these components, and dropping the Notebook could cause the screen to crack, base unit to crack or chip, and shock the Hard Drive causing any or all of those components to fail or be partially damaged. Ordering a replacement module will be much more cost effective than having to get the whole unit repaired.

### DETAILS

### Drawings List

3D-1 Notebook Assembly Rendering

3D-2 Exploded View Left

3D-3 Exploded View Right

2D-4 Notebook Plan View

Component list

USB001—2 USB ports

NET002—1 Ethernet port, Wifi, Bluetooth unit

AUD003—Speakers, Audio Input Jack, Microphone Jack

HDB004—Hard Drive Bracket

VID005—1 HDMI port, 1 VGA port

BAT006—1 Battery

PWR007—Power Button and status lights

SCN008—Screen

KEY009—Keyboard, Touchpad

### DETAILS LIST

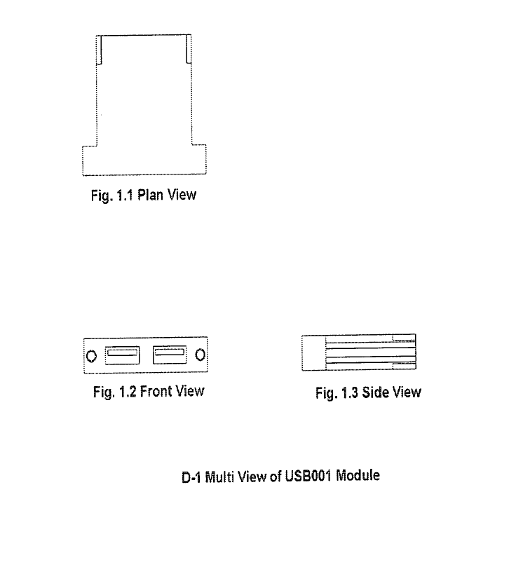

D-1 Multi View of USB001 Module
FIG. 1.1 Plan View
FIG. 1.2 Front View
FIG. 1.3 Side View

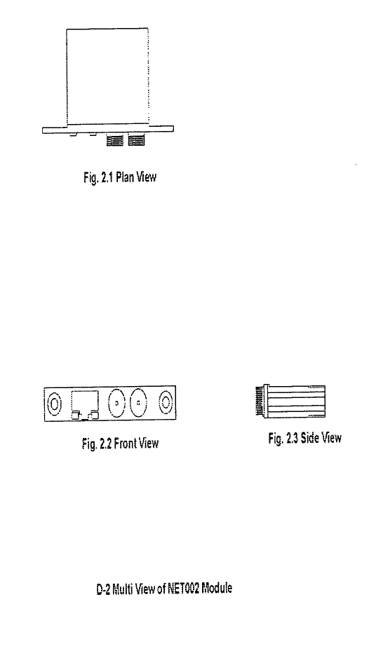

D-2 Multi View of NET001 Module
FIG. 2.1 Plan View
FIG. 2.2 Front View
FIG. 2.3 Side View

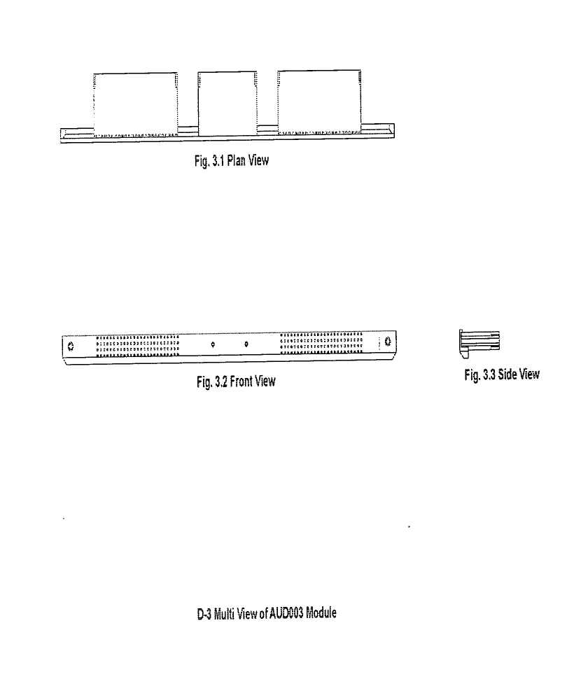

D-3 Multi View of AUD001 Module
FIG. 3.1 Plan View
FIG. 3.2 Front View
FIG. 3.3 Side View

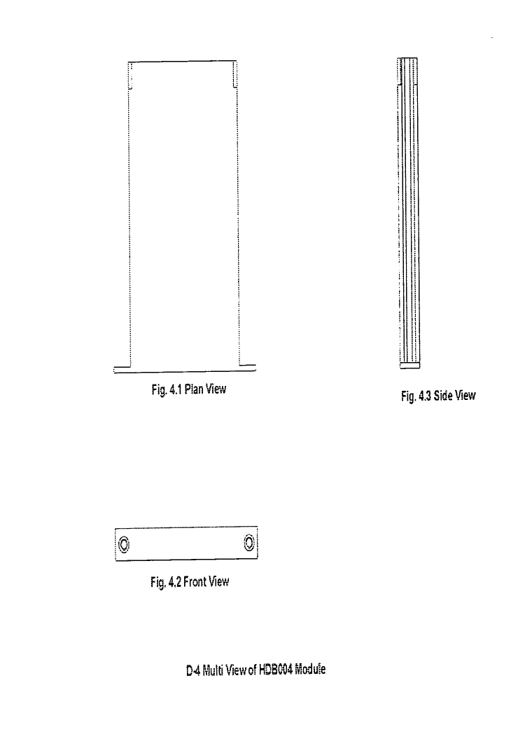

D-4 Multi View of HDB001 Module
FIG. 4.1 Plan View
FIG. 4.2 Front View
FIG. 4.3 Side View

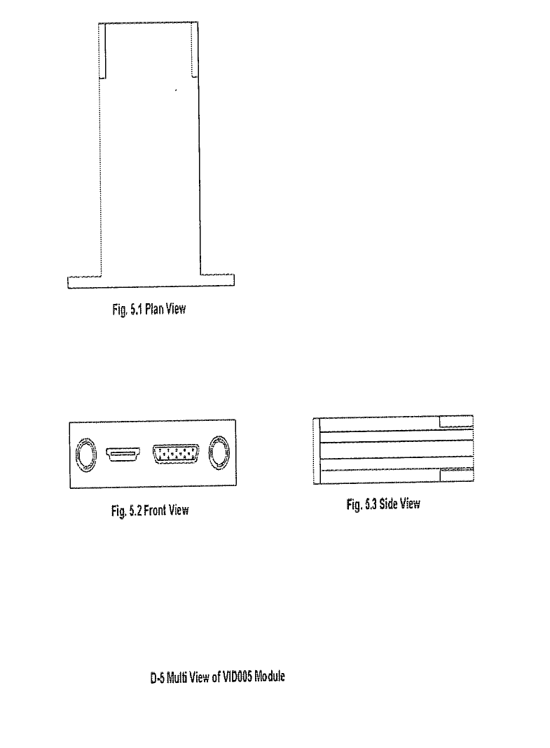

D-5 Multi View of VID001 Module
FIG. 5.1 Plan View
FIG. 5.2 Front View
FIG. 5.3 Side View

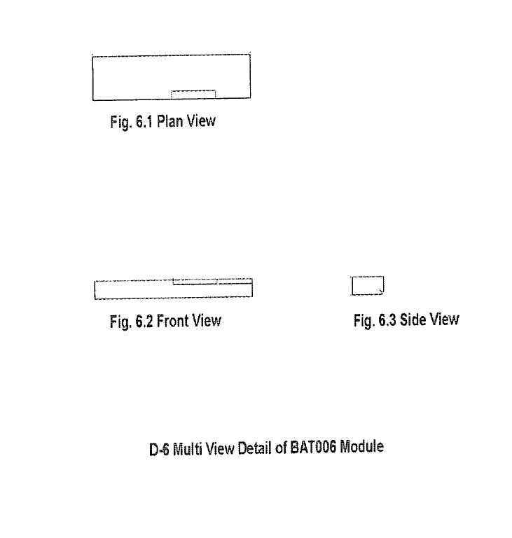

D-6 Multi View of BAT001 Module
FIG. 6.1 Plan View
FIG. 6.2 Front View
FIG. 6.3 Side View

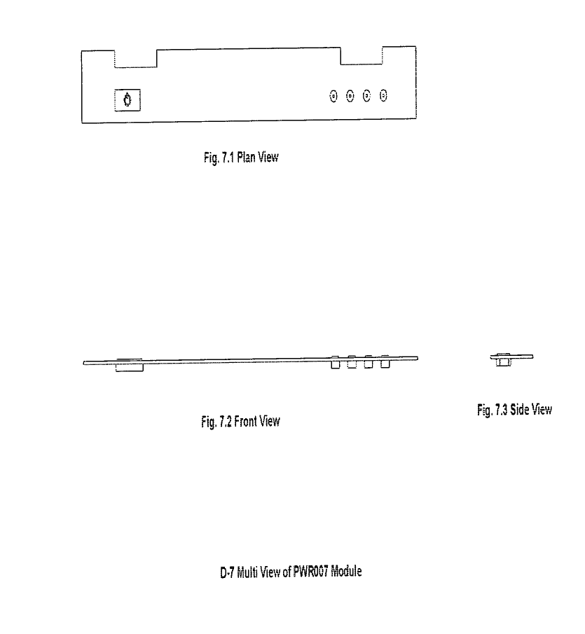

D-7 Multi View of PWR001 Module
FIG. 7.1 Plan View
FIG. 7.2 Front View
FIG. 7.3 Side View

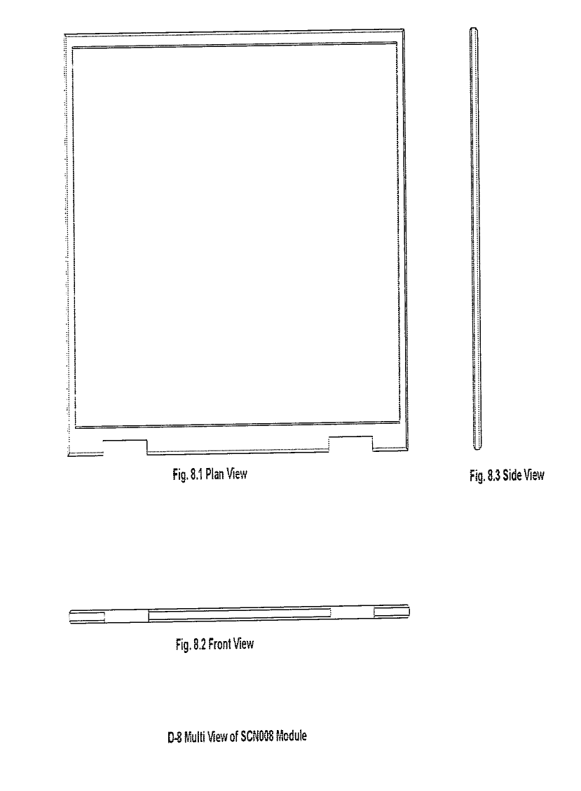

D-8 Multi View of SCN001 Module
FIG. 8.1 Plan View
FIG. 8.2 Front View
FIG. 8.3 Side View

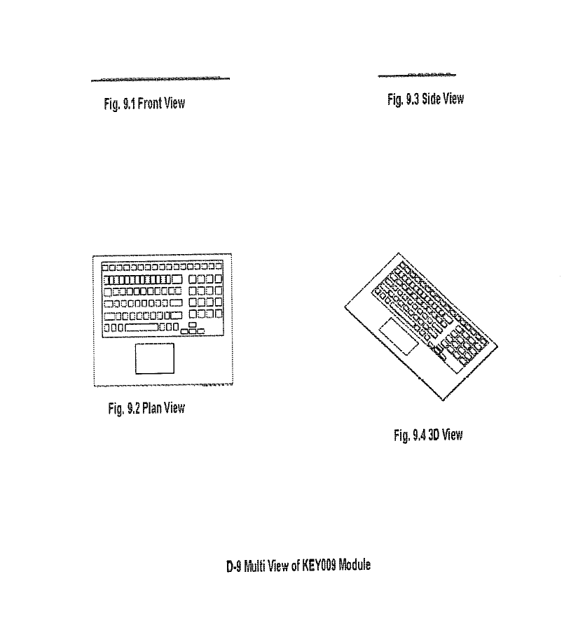

D-9 Multi View of KEY001 Module
FIG. 9.1 Front View
FIG. 9.2 Plan View
FIG. 9.3 Side View
FIG. 9.4 3D view

1) The improvement is the ability for a person who owns a laptop/notebook (herein known as Notebook) computer to be able to service the device themselves when a hardware malfunction occurs.

2) The Notebook will have color coded markings on the Base* of the unit so each color coded peripheral is easily identifiable as to where it is to be connected to the Base.

3) The peripherals will be connected by an industry standard high speed connection type for internal component connections on the main board inside the Base.

4) The peripherals will be connected to the frame of the Base by a built in screw on each side with stops on the screw to prevent it from being removable from the peripheral itself.

5) Peripherals will be recognizable by a color code and owner/user can become familiar with components on their Notebook making tech support a positive experience.
